(19) United States
(12) Patent Application Publication
(10) Pub. No.: US 2008/0243865 A1
(43) Pub. Date: Oct. 2, 2008

(54) Maintaining global state of distributed transaction managed by an external transaction manager for clustered database systems

(75) Inventors: Yong Hu, Foster City, CA (US); Bipul Sinha, Foster City, CA (US); Amit Ganesh, San Jose, CA (US); Juan Loaiza, Woodside, CA (US); Vivekanandhan Raja, Foster City, CA (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: Oracle International Corporation, Redwood Shores, CA (US)

(21) Appl. No.: 11/729,473

(22) Filed: Mar. 28, 2007

(51) Int. Cl. G06F 17/30

(52) U.S. Cl. 707/10; 707/E17.032

(57) ABSTRACT

In accordance with an embodiment of the present invention, a transaction tracking mechanism is provided by a database server cluster to keep track of a global state of a distributed transaction. The global state of the distributed transaction comprises one or more statuses that are associated with one or more transaction branches that are part of the distributed transaction. The global state may be associated with a global lock. Through using the global state in association with the global lock, problems such as partial commits, data inconsistency, access contentions and deadlocks may be avoided when the database server cluster processes the distributed transaction.

### FIELD OF THE INVENTION

The present invention relates to database systems and, more specifically, clustered database systems that support distributed transaction processing.

### BACKGROUND

A database server cluster is a set of two or more server instances that forms a cluster to process requests from database clients relating to a (shared) data source. Examples of such database server clusters are Oracle Real Application Clusters (RAC), commercially available from Oracle Corporation (e.g., 10 g or later versions). Here, the data source may be, but is not limited to, a database, datafile(s), etc.

In an environment where a database server cluster is used, transaction branches that make up a distributed transaction may be executed by two or more server instances (or nodes) of the cluster. As a result, performance, availability and scalability of transaction processing are improved. However, transaction integrity (e.g., atomicity, consistency, isolation and durability, also known as ACID) could be compromised because of cluster-related issues (e.g., access contentions, lock conflicts, data inconsistencies, etc.).

Transaction integrity is relatively easy to maintain in a local transaction processing model, even where a database server cluster is involved. In this model, the database server cluster is allocated the task to maintain overall transaction integrity. Having knowledge about its own server instances, the cluster can coordinate server instances, for example, to prepare for committing any changes made. Subsequently, the cluster may cause the server instances to finally commit the changes. Likewise, a rollback can be similarly coordinated in the local transaction processing model. In fact, where the cluster is an Oracle RAC cluster, a local transaction is typically performed within the scope of a session, whose lifecycle in turn is within the scope of a single server instance of the cluster.

However, transaction integrity is difficult to maintain in a distributed transaction processing model. In such a model, a transaction manager, which may be located in an application server external to the database server cluster, is allocated the overall task to coordinate, prepare, commit or rollback a transaction. Such a transaction manager can be a generic, off-the-shelf product that may come from a vendor that is different from the one who supplies the database server cluster or software deployed therein. As such, the transaction manager may implement an industry standard such as X/Open DTP and thus have little notion as to how underlying database services are provided (e.g., whether they are provided through a single database server or a database server cluster comprising multiple server instances). Based on the industry standard, the transaction manager may simply abstract a provider of the underlying database services as one or more resource managers.

Furthermore, a distributed transaction may comprise multiple transaction branches. Each of the multiple transaction branches may be executed by a same or different server instance of the database server cluster. However, being external to the cluster, the transaction manager may not know that multiple branches of the same distributed transaction may have been executed by different server instances of the cluster. Thus, the transaction manager may not be able to resolve issues of access contentions, lock conflicts, data inconsistencies, etc., among the server instances in the underlying database server cluster. As a result, problems such as partial commit, dead lock, data inconsistency, etc., may occur.

Therefore, a better mechanism that would improve distributed transaction processing in an environment involving a database server cluster is needed.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a functional block diagram of a system in which an embodiment of the present invention may be implemented.

FIG. 2 is a flow diagram that illustrates a process for supporting distributed transaction processing in a database server cluster, according to an embodiment of the present invention.

FIG. 3 is a flow diagram that illustrates a process for supporting distributed transaction processing in a database server cluster, according to another embodiment of the present invention.

FIG. 4 is a block diagram of a system upon which the techniques described herein may be implemented.

### DETAILED DESCRIPTION

In the following description, for the purposes of explanation, numerous specific details are set forth in order to provide a thorough understanding of various embodiments of the invention. It will be apparent, however, that the present invention may be practiced without these specific details. In other instances, well-known structures and devices are shown in block diagram form in order to avoid unnecessarily obscuring the present invention.

### Functional Overview

In accordance with an embodiment of the present invention, a transaction tracking mechanism is provided by a computer system to keep track of a global state of a distributed transaction in a clustered database. In some embodiments, the computer system is a database server cluster comprising two or more server instances.

In an embodiment, the distributed transaction is managed by a transaction manager that executes on a node different from the two or more server instances. In an embodiment, the clustered database stores, within itself (in an accessible data storage or memory space), information in association with the distributed transaction that indicates a global status of the distributed transaction. In some embodiments, the distributed transaction (its one or more transaction branches) may be executed by any available server instances of the clustered database. The information in association with the distributed transaction is known as a global state of the distributed transaction. In an embodiment, the global state is created when any work relating to the distributed transaction is started or processed by the cluster. In an embodiment, the global state is destroyed when the distributed transaction is rolled back (aborted), or committed. As used herein, the term “destroy” means that the cluster may not need the global state and that any memory allocated to store the global state may be freed.

The global state of the distributed transaction comprises one or more branch statuses, each of which is associated with one of the transaction branches. The first time a transaction branch, through an associated server process on a server instance, is used to perform a unit of work, a branch status is created and stored in the information in association with the (global) distributed transaction. Thereafter, each time the transaction branch is used to perform a new unit of work, the branch status is updated to store a status (e.g., successful or failed) for performing that new unit of work. Thus, if a transaction branch is used to perform multiple units of work, a status for each of the multiple units of work is created and stored in a branch status (as part of the information in association with the distributed transaction). Particularly, any of the one or more branch statuses for a distributed transaction may comprise an indication of a success or a failure relating to performing a two-phase transaction commitment for an associated transaction branch. In an embodiment, whenever a transaction branch is called to perform a unit of work, the transaction branch first accesses the information in association with the distributed transaction. Since the global state stores statuses relating to other units of work performed by other transaction branches, the transaction branch, or its associated server process, may see what happens with any particular unit of work that has already been performed by all the other transaction branches.

Statuses relating to work performed by other transaction branches may be used by the (current) transaction branch in many different ways. For example, the transaction branch, or an associated server process, may use those statuses to determine whether any changes made by the transaction branch are to be rolled back (aborted), or committed. For example, if another transaction branch in the same distributed transaction indicates a failure in preparing for committing its changes in response to a prepare call invoked by the transaction manager, then the transaction branch may decide to roll back its own changes as well. Thus, problems such as partial commits and data inconsistencies can be avoided.

In an embodiment, the global state is stored in association with a global lock. In an embodiment, the global lock is a data structure that, if granted, secures a grantee (e.g., a transaction branch or a server process thereon) of certain access permissions in the scope of the distributed transaction executed by the clustered database (or rather its server instances). The cluster may grant the global lock associated with the distributed transaction to server processes on two or more server instances of the clustered database at a time. The global lock may be used by the clustered database to lock access to the statuses of transaction branches in the global state, or to serialize execution of two or more server processes that work on the same distributed transaction, or to coordinate prepare/rollback/commit of the distributed transaction or transaction branches therein. The global lock is globally recognized and enforced for and/or by all instances within a multi-node clustered database system. If multiple grants of the global lock are made, these grants of the lock must be compatible. That is, when a global lock in a certain mode is granted to a process of an instance, the global locking mechanism will not grant the global lock in an incompatible mode to any other process of the instance or another instance. In an embodiment, the global lock may be granted in an exclusive mode. In the exclusive mode, only one entity is allowed to hold the lock and all other entities are excluded. Thus, if a server process is granted the global lock in the exclusive mode, any other server processes are excluded from holding same, irrespective of in what mode (e.g., a shared mode for read-only access) those other server processes wish to hold the lock. In an embodiment, the global lock is granted in an exclusive mode as default. Thus, in the default mode, only one lock grant may be made at any given time in that embodiment.

In an embodiment, the global lock may be in a shared mode. In the shared mode, one or more entities may be concurrently allowed to hold the lock if all those entities request for the lock in a shared mode. Thus, if a server process is granted the global lock in the shared mode, any other server processes that wish to hold same in the shared mode may be granted the lock. However, any server process that wishes to be granted the lock in an exclusive mode would be excluded.

In an embodiment, before performing a unit of work, a transaction branch has to acquire the global lock in association with the distributed transaction first. Correspondingly, whenever the transaction branch finishes with the unit of work, the transaction branch releases the global lock previously acquired. The transaction branch may repeat this sequence of acquiring the lock, performing work and releasing the lock zero or more times. Other transaction branches of the specific distributed transaction may also go through this sequence of acquiring the lock, performing work and releasing the lock one or more times. Those sequences from different transaction branches may interleave with one another. In this manner, the global lock can be used by the one or more transaction branches of the specific distributed transaction in serializing their units of work. For example, the transaction branch, or an associated server process, may use the global lock in an exclusive mode to prevent any other transaction branch, or its associated server process, from performing any unit of work. Thus, the transaction branch may manipulate any shared resources including shared datasets stored in the database without interference from other transaction branches. In particular, when multiple transaction branches are to modify a shared dataset, the modifications may be performed in a serialized manner using the global lock. As a result, problems such as deadlocks may be avoided.

The transaction tracking mechanism in the present invention in various embodiments may be used regardless of what the data source is. For example, the data source may be a relational database, datafile(s), etc. Furthermore, the transaction tracking mechanism may be used with any type of computer systems, not just database systems, as long as multiple server instances are involved. The computer system may be made of one or more general purpose computers or one or more devices that are specifically optimized for performing database service functions, as long as multiple server instances (which may be deployed on virtual or physical machines) are involved.

### Example Processing Model

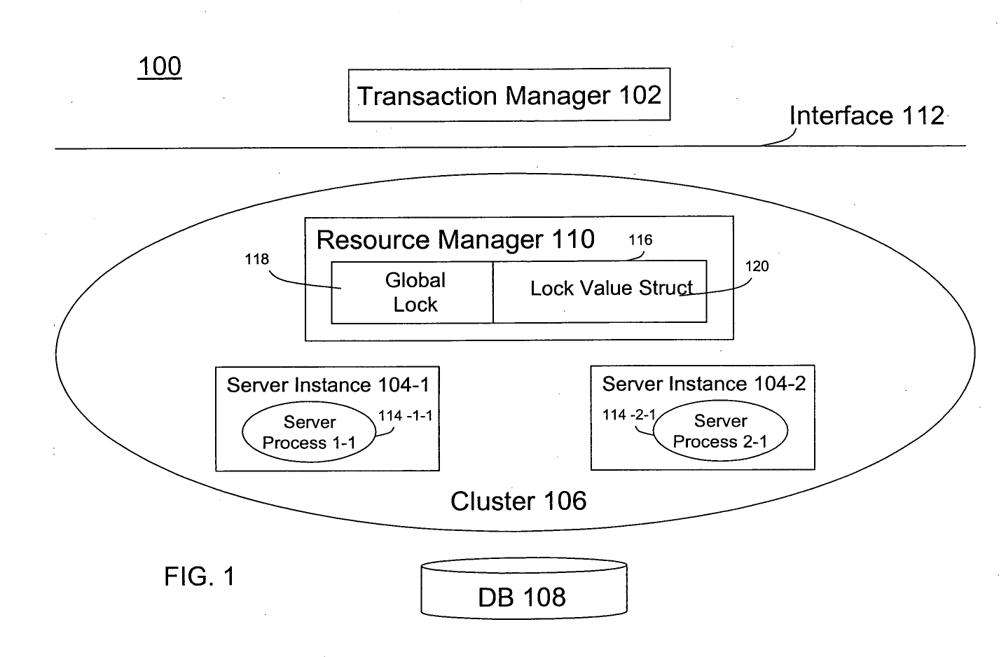

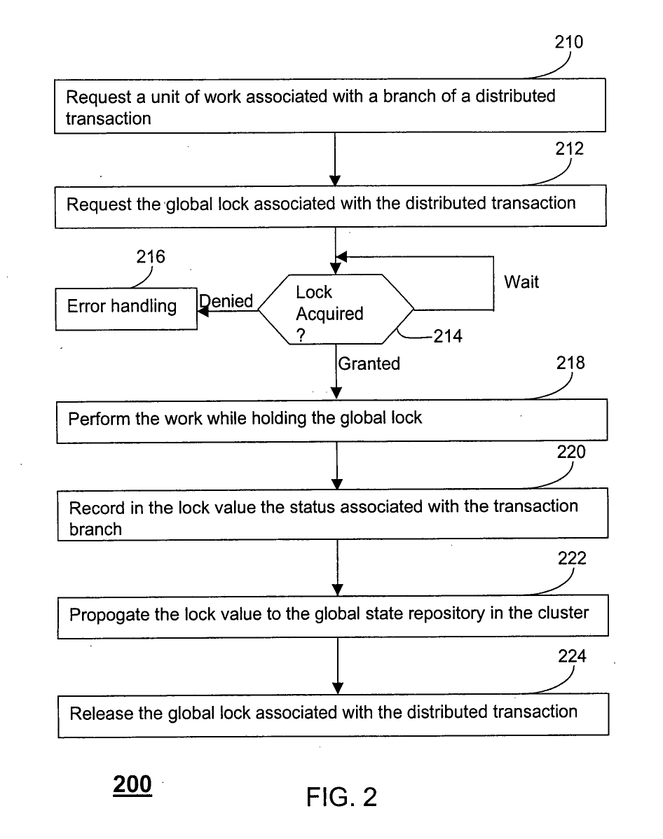

With reference to FIGS. 1 and 2, there is shown a functional block diagram of a system 100 and a flow diagram 200 in which an embodiment of the present invention may be implemented. As shown, the system 100 of FIG. 1 comprises a transaction manager 102, a plurality of server instances 104 that form a cluster 106, a database (DB) 108 for which the plurality of server instances 104 are used to process requests, a resource manager 110, and an interface 112 between the transaction manager 102 and the resource manager 110.

In an embodiment, the transaction manager 102 may reside on an application server (not shown) in a three-tier processing model. Under this model, a user or a user computing device (first tier) may invoke business logic implemented by the application server (second tier). The business logic on the application server may in turn invoke database services such as transaction processing services provided by a database server or a database server cluster such as the cluster 106 shown here (third tier). In various embodiments, network links between the user computing device and the application server (or one or more computing devices that hosts the application server) and between the application server and the database server cluster such as the cluster 106 may be provided by local area networks (LANs, such as Ethernet, Token Ring), wide area networks (WANs, such as Internet), system/storage area networks (SANs, such as InfiniBand, Fibre Channel), or any combination thereof. In an embodiment, the transaction manager 102 is responsible for maintaining transaction integrity for (database) transactions that are created by the business logic of the application server.

The plurality of server instances 104 may comprise any number of computer nodes. In an embodiment, the server instances 104 are interconnected with high-speed interconnects. In an embodiment, the interconnects may be used by the server instances 104 to exchange messages, share data, synchronize transaction branches, or coordinate accesses to the database 108, etc.

In an embodiment, the resource manager 10 resides within the cluster 106. In an embodiment, the resource manager 10 is a distributed application in the cluster 106 that help provide access to shared resources including computing, networking and database resources, taking advantage of the high-speed interconnection between and among the server instances 104. As used herein, the term “a distributed application” refers to an application that is synergistically formed as a whole by constituent parts in a distributed computing devices system such as server instances 104. In an embodiment, to process a distributed transaction, the transaction manager 102 interacts with the resource manager 110. This interaction as noted before is through the interface 112. In an embodiment, the interface 112 is an XA interface specified by the X/Open DTP standard.

### Units of Work

A server instance 104 may host a number of foreground and background processes. Among these foreground and background processes, a group of one or more server processes 114 may be used to process units of work relating to the distributed transaction. In an embodiment, the server processes 114 are stateless in terms of the work that they are performing, meaning that, after they finish the units of work that were assigned to them, they may be re-assigned to process other units of work relating to the same distributed transaction or any other transactions. As used herein, the term “a unit of work” may refer to an operation, to be performed by the server instances, that is requested by the transaction manager. Examples of operations requested by the transaction manager may include, but are not limited to, a standard SQL statement (such as “select”, “insert”, “delete”, or “update”), an API call (such as create, update or delete a transaction branch), etc.

In an embodiment, the transaction manager 102 manages the distributed transaction in one or more transaction branches. In an embodiment, the one or more transaction branches are tightly-coupled. As used herein, the term “tightly-coupled” means that transaction branches that are tightly-coupled may access one another's data including a current version of the data that may be altered or derived from a version that is stored in the database 108.

In an embodiment, the transaction manager 102 may use a transaction branch to request the resource manager 110 to handle one or more units of work (step 210 of FIG. 2). The resource manager 110 in turn may associate each of one or more units of work with an available server process 114 that is located in a server instance 104 and assign (or cause to assign) the server process 114 to perform the unit of work associated. Under this scheme, a unit of work performed by a server instance 104 for the distributed transaction may be associated with a transaction branch through a server process 114. Thus, when the server process 114 finishes with the unit of work, the server process 114 can store in the global state a status relating to the unit of work performed. This status may comprise information that identifies where (i.e., which server instance) the work is performed and for what transaction branch. This status information is kept in the global state for the life of the distributed transaction even though the server process 114 which performed the unit of work may at present be dissociated from the transaction branch and associated with a different distributed transaction.

In an embodiment, units of work associated with different transaction branches may be performed by server processes 114 on different server instances 104. For example, a unit of work associated with a transaction branch, say branch A, may be performed by a server process, say 114-1-1, on server instance 104-1, while another unit of work associated with another transaction branch, say branch B, may be performed by another server process, say 114-2-1, on server-instance 104-2.

In an embodiment, a transaction branch may, at various times, be associated with two or more units of work and the two or more units of work associated with the transaction branch may be performed by server processes 114 on different server instances 104. For example, a unit of work, say work A, for such a transaction branch may be performed on the server process 114-1-1 on the server instance 104-1, while another unit of work, say work B, for the same transaction branch may be performed by the server process 114-2-1 on the server instance 104-2.

As this discussion shows, different transaction branches of a same distributed transaction at the transaction manager level may, at various times, be associated with different server processes 114 located on different server instances 104 of the cluster 106. Moreover, for a single transaction branch, different units of work associated with the transaction branch may, at various times, be associated with different server processes 114 located on different server instances 104.

### Lock Value Structures

In accordance with an embodiment of the present invention, the resource manager 110 keeps information 116 in association with the distributed transaction to indicate a detailed status of the distributed transaction. As noted, such information 116 is also known as a global state of the distributed transaction. In an embodiment, the global state 116 is stored in a data structure that comprises one or more lock value structures 120 in association with a global lock 118. In an embodiment, each lock value structure 120 stores a status of a unit of work that is associated with a transaction branch. In another embodiment, each lock value structure 120 stores a status of a transaction branch that is associated with one or more units of work. Since a unit of work is associated with a transaction branch in an embodiment, a status that is associated with the unit of work and stored in a lock value structure 120 is also associated with a transaction branch. Each time a server process 114 on a server instance 104 is associated (or attached) to a transaction branch and is used by the transaction branch to perform a particular unit of work, a status relating to that particular unit of work is created and stored in the global state 116.

In an embodiment, whenever a transaction branch is called to perform a unit of work, an associated server process 114 may access the global state 116 by requesting the global lock associated with the distributed transaction (step 212 of FIG. 2). As will be explained, a server process 114 may acquire the global lock 118 in an exclusive mode. Such a server process 114 may create and store a lock value structure 120 in the global state 116 to indicate a status of a particular unit of work the server process 114 performed. In an embodiment, a server process 114 that obtains the global lock 118 in a shared mode does not make any change to data to be concurrently shared by other server processes 114 in various server instances 104 of the cluster 106 or to be committed to the database 108. In other words, in this embodiment, the lock value structures 120 stored with the global state 116 comprise statuses of units of work that relate to non-read-only operations.

In an embodiment, after receiving a request to prepare for committing a transaction branch of the distributed transaction, the resource manager 110 determines the status of the distributed transaction using the global state 116. In an embodiment, the status derived from the global state 116 comprises one or more statuses for one or more transaction branches that include the transaction branch that is being prepared for committing. Based on the status of the distributed transaction, the resource manager 110 manages preparation for committing the transaction branch accordingly. For example, if the status indicates a prior transaction branch was rolled back (aborted), a server process may choose to abort the transaction branch that is being currently requested as well. On the other hand, for example, if all other prior transaction branches have been successfully prepared for committing, then the server process may proceed to prepare for committing for the transaction branch that is being currently requested.

### Global Lock

As noted before, in an embodiment, the global state 116 is stored in association with a global lock 118. In an embodiment, before performing a unit of work, the transaction branch (or its associated server process 114) has to acquire the global lock 118 first. Correspondingly, whenever the associated server process 114 finishes with the unit of work, the server process 114 releases the global lock 118 previously acquired. The global lock 118 can be used by the transaction branches of the distributed transaction in serializing their units of work. For example, a server process 114 associated with a transaction branch of the distributed transaction may use the global lock 118 in an exclusive mode to exclude other server processes 114 that are associated with transaction branches of the same distributed transaction from owning or acquiring the global lock 118, thereby preventing those other server processes 114 from performing other units of work. By using the global lock 118 this way, it may be guaranteed that only one server process 114 associated with the overall distributed transaction may modify shared data or resources at one time.

In an embodiment where the global lock 118 is acquired in a shared mode, one or more server processes 114 may be concurrently allowed to hold the global lock 118 if all those server processes 114 specifically request for the global lock 118 in a shared mode. However, any server process 114 that wishes to be granted the lock 118 in an exclusive mode would be excluded until all those server processes 114 relinquish their ownerships of the global lock 118 (in the shared mode). In an embodiment, if the lock 118 cannot be granted to a requesting server process, the requesting server process may be blocked or placed in a wait loop until the lock is acquired or granted (step 214 of FIG. 2). In some embodiments, when the lock 118 has been requested but cannot be granted to a requesting process, an error indication is immediately returned to the requesting process for appropriate error handling (step 216 of FIG. 2). On the other hand, if a server process 114 is previously granted and still holds the global lock 118 in the shared mode, any other server processes 114 that wish to hold same in the shared mode may be granted the lock.

After the global lock 118 is granted to a server process, the server process may perform any unit of work while holding the lock 118 (step 218 of FIG. 2). In addition, the server process may record information in the lock value structure associated with the transaction branch that is part of the distributed transaction (step 220 of FIG. 2). Particularly, the server process may record the status of performing the unit of work in an associated branch status, as previously described. Such a status recorded in the lock value structure is automatically propagated to subsequent holders of the global lock 118 because the lock value structure is stored in the global state of the distributed transaction in the previously mentioned repository of global states (step 222 of FIG. 2). When the server process finishes all units of work requested, it may request the resource manager to release the global lock (step 224 of FIG. 2).

### Global Transaction Identifier and Branch Identifier

In an embodiment, a user may use a browser to interact with business logic on an application server, which in turn causes a distributed transaction to be created by an entity on the application server such as the transaction manager 102 shown in FIG. 1. In an embodiment, for the purpose of creating the distributed transaction and invoking database services relating to the distributed transaction, the transaction manager 102 may follow the X/Open DTP model. In this model, the transaction manager 102 may concurrently manage multiple distributed transactions. In an embodiment, the transaction manager 102 assigns a globally unique transaction identifier to each of the multiple distributed transactions. As noted before, each distributed transaction may comprise one or more transaction branches. In an embodiment, the transaction manager 102 assigns further a unique branch identifier to each transaction branch in a distributed transaction. The scope of uniqueness for branch identifiers is limited to a distributed transaction to which the one or more transaction branches belong. For example, if the distributed transaction here comprises three transaction branches, then each of the three transaction branches may be assigned a unique branch identifier to distinguish from one another within the distributed transaction.

In an embodiment, a request, which the resource manager 110 receives from the transaction manager 102, contains a global transaction identifier assigned to the distributed transaction and a branch identifier assigned to a transaction branch of the distributed transaction. In an embodiment, the global transaction identifier and the branch identifier are contained in an XID object (defined in the X/Open DTP model) in the request (which may be in the form of an XA interface function call). In an embodiment, the transaction manager 102 may indicate in the request (e.g., an XA_START( ) function call) whether a new transaction branch is to be created using a flag (e.g., TMNOFLAGS), whether an existing transaction is to be resumed using another flag(e.g., TMRESUME), etc. In the present example, since the distributed transaction is just created by the transaction manager 102, the transaction manager 102 would indicate in the request a new transaction branch is to be created.

In an embodiment, the resource manager 110 maintains a repository of global states, each global state being associated with a corresponding global transaction identifier.

Upon receiving a request such as the request from the transaction manager 102 here, the resource manager 110 may extract the global transaction identifier from the request and look up in the repository to see if there is already a global state associated with the global transaction identifier.

If the distributed transaction is newly created, then there is no global state yet in the cluster. In that case, the resource manager may proceed to allocate memory, create a global state 116 and associate the newly created global state 116 with the global transaction identifier. As noted before, in general, the global state 116 may be used to store statuses relating to transaction branches. Initially, since no prior transaction branch of the distributed transaction has requested the cluster 106 to execute any unit of work, the global state 116 may contain zero lock value structure.

As a consequence of receiving the request, a server process 114 may be created, dispatched, attached or otherwise associated with the transaction branch to perform the unit of work in association with the request related to the transaction branch. In an embodiment, the server process 114 may be one of pre-started server processes in a pool and may be associated with any transaction branch. In another embodiment, the server process 114 may be started on demand by the cluster 106 to handle the request for performing the unit of work from the transaction manager 102. In an embodiment, the global transaction identifier and the branch identifier (e.g., in an XID-like object) is provided to the server process 114 when the server process 114 is associated with the transaction branch.

The server process 114 may make a request for the global lock 118 in an exclusive mode. The request for the global lock 118 may carry a combination of the global transaction identifier and the branch identifier. The reason for getting the global lock 118 in the exclusive mode varies. For example, the server process 114 may like to update the global state 116; and the global lock 118 may be used to exclude other server processes from doing the same.

Upon receiving the request for the global lock 118 from the server process 114, the resource manager may determine the global transaction identifier from the server process's request and use the global transaction identifier to locate the associated global lock. Next, the resource manager determines whether the global lock 118 is already granted to a server process. Since this is a new transaction branch (i.e., the cluster receives a branch identifier the first time relating to the distributed transaction), the resource manager 110 may determine that no other server process currently holds the global lock 118 and thus the requesting server process 114 may be granted the global lock 118 in the exclusive mode. The server process 114 may perform the unit of work while holding the global lock 118 and when performing the unit of work reaches a conclusion, the server process 114 may create a lock value structure (struct) 120, update an appropriate status (e.g., success, failed, etc.) in the lock value structure 120 and store the lock value structure 120 in the global state 116.

On the other hand, if the resource manager 110 determines that another server process is currently holding the global lock 118, then this may mean that either this transaction branch is a duplicate transaction branch or the distributed transaction itself is a duplicated transaction. Since there may be allowed only one distributed transaction uniquely associated with one global transaction identifier and/or one transaction branch within the distributed transaction uniquely associated with one branch identifier, the resource manager 110 may determine and flag this as an error that was made by the transaction manager and rejects the request for the global lock 118. In this manner, a duplicative transaction branch from a duplicative distributed transaction, e.g., as a result of a misbehaving transaction manager or application server programming errors, may be detected by the resource manager 110. In this manner, any request for performing work from the duplicative transaction branch or the duplicative distributed transaction is rejected before any harm is done.

Furthermore, even if a particular transaction branch and another transaction branch duplicative to the particular transaction branch end up being associated with different server processes 114 that are located on different server instances 104, this duplication may still be easily detected using the global state 116, since the global state 116 stores cluster-wide statuses of the distributed transaction and cluster-wide lock ownership information.

### Uses of the Global State

As this discussion indicates, through the lock value structures 120 in the global state 116, a subsequent server process 114 may see statuses associated with prior units of work already performed and use these statuses to determine what action the subsequent server process 114 may take. For example, in an embodiment, an indication of a success or a failure relating to performing a two-phase transaction commitment for a transaction branch may be found by reading a (branch) status that is associated with the transaction branch. Using the global lock 118 in the global state 116, accesses to resources or units of work can be serialized.

For example, as noted before, a server process 114 that wishes to update the global state (for example, to store a new lock value structure 120 in the global state 116) may use the global lock 118 to block other processes from concurrent updates. In an embodiment, according to whether an intended operation is read-only or not, the server process 114 makes a request for the global lock 118 in a shared mode or an exclusive mode. In another embodiment, the default mode for the global lock 118 is exclusive; a server process 114 holds the global lock 118 in an exclusive mode no matter whether an intended operation by the server process 114 is read-only or not.

As a further example of how the global state 116 and its constituent parts (such as the global lock 118 and the lock value structures 120) may be used in distributed transaction processing, suppose that the distributed transaction is now nearly complete and that the transaction manager 102 now requests all transaction branches to prepare for committing changes made. In an alternative embodiment, the transaction manager 102 may request only those transaction branches that made data changes to prepare for committing, but not those that only perform read-only operations. This preparation for committing changes made, requested by the transaction manager 102, is itself a unit of work for a transaction branch that receives the request for preparing for committing. Accordingly, just like any other unit of work, this unit of work may be associated with a server process 114, say the server process 114-1-1. The server process 114-1-1 may acquire the global lock 118 in an exclusive mode, thereby preventing all other server processes 114 including the server process 114-2-1 from performing operations relating to the distributed transaction.

Next, the server process 114-1-1 may examine the content of the global state 116 to see if another server process 114, say the server process 114-2-1, also performed a preparation for committing (i.e., a unit of work). If so, the server process 114-1-1 further examines the status of the preparation for committing by the other server process 114-2-1 and determines whether the status is successful or failed. If the status for the preparation for committing by the other server process 114-2-1 indicates a success, the server process 114-1-1 continues to prepare for committing, and a new lock value structure containing a status as to whether the preparation for committing by the server process 114-1-1 is successful or failed is created and stored in the global state 116. However, if the status for the preparation for committing by the other server process 114-2-1 indicates a failure, the server process 114-1-1 would rollback (abort) any changes made without committing them.

As this discussion shows, even though the transaction manager 102 may be assigned the role to coordinate a two-phase transaction commitment for the distributed transaction (i.e., has the responsibility to issue calls such as prepare, commit, etc. and coordinate those calls), server processes 114 that perform transaction-related work have sufficient history and status information about the distributed transaction in the global state to perform the work correctly. Furthermore, even if the transaction manager 102 misbehaved in coordinating the distributed transaction (e.g., as a result of an application server programming error, a prepare call is missed for one transaction branch), given the global state, a server process 114 would be able to find out which transaction branch was not prepared. For example, in the embodiment where all transaction branches (whether read-only or not) have to prepare for committing, the last server process 114 among all the server processes that perform the preparation step, or the first server process 114 among all the server processes that perform a commit step subsequent to the preparation step may detect that a transaction branch missed a preparation step. Therefore, an error may be noted and the distributed transaction may still be rolled back. Clearly, given the global state, the cluster 106, or server processes 114 hosted by the cluster 106, becomes relatively resilient in handling transaction errors such as discussed above.

### Example Operation

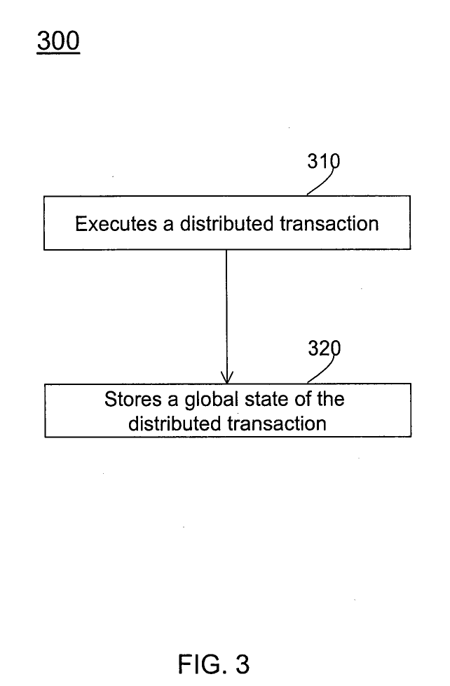

FIG. 3 is a flow diagram that illustrates a process 300 for supporting distributed transaction processing in a database server cluster, according to an embodiment of the present invention.

At step 310, a computer system, which in an embodiment comprises two or more server instances (e.g., 104 of FIG. 1), executes one or more branches of a distributed transaction. The distributed transaction is managed by a transaction manager such as 102 of FIG. 1. In an embodiment, the transaction manager 102 executes on a node that is different from the two or more server instances 104.

In an embodiment, the two or more server instances 104 may form a database server cluster such as the cluster 106 of FIG. 1 for a single database source such as DB 108. In an embodiment, the two or more server instances 104 each host a plurality of server processes 114. The plurality of server processes 114 may be used to perform units of work associated with the one or more transaction branches.

At step 320, the cluster 106 stores, within an accessible storage of the cluster, information in association with the distributed transaction such as 116 of FIG. 1. As noted before, the information is known as a global state of the distributed transaction that indicates a status of the distributed transaction.

When the cluster 106 assigns a unit of work to a server process 114, in response, the cluster 106 may receive a request from the server process 114 for the global state 116. As noted before, in an embodiment, since the unit of work is associated with a transaction branch of the distributed transaction, the server process 114 is thus also associated with the transaction branch.

Upon receiving the request for the global state 116, the cluster 106 retrieves the global state and determines whether to grant the global lock 118 contained therein to the server process 114. To determine this, the cluster 106 may determine whether the global lock 118 is currently granted to another server process 114. In response to a determination that the global lock 118 is not currently granted to another server process 114, the cluster 106 may grant the global lock 118 to the server process 114.

After the global lock 118 is granted to the server process 114, the cluster 106 may use the server process 114 to perform a unit of work, to store a lock value structure 120 in the global state 116, and to release the global lock 118 by updating the global state 116 to indicate that the global lock 118 is no longer granted to the server process 114. The unit of work here may comprise preparing for committing the (global) distributed transaction.

If the cluster 106 determines that the global lock 118 is currently granted to another server process 114, then in response to this determination, the cluster 106 may determine whether the global lock 118 can still be granted to the server process 114. To make this determination, the cluster 106 may determine whether the global lock 118 is currently granted to the other server process 114 in an exclusive mode. If that is the case, the cluster 106 denies the request for the global lock 118 by the server process 114 in an embodiment. Rather than denying the request for the lock, in another embodiment, the cluster 106 may instead delay denying the global lock 118 to the server process 114 and instead grant the lock after the other server process 114 releases the global lock 118.

In determining whether the global lock 118 can be granted to the server process 114, the cluster 106 may also determine whether the global lock 118 is currently granted to the other server process 114 in a shared mode. In response to a determination that the global lock 118 is currently granted to the other server process 114 in a shared mode, the cluster may determine whether to grant the global lock 118 to the server process 114 in a shared mode. This may be done by first determining whether the request for the global lock 118 specifies a shared mode. If that is the case, the cluster 106 may grant the global lock 118 to the server process 114 in a shared mode.

In an embodiment, the global state is implemented as a data structure whose size may be varied. For example, the data structure may be allocated additional space and may be de-allocated some space, in order to store a variable number of lock value structures 120.

In an embodiment, a lock value structure 120 may store pointers to undo records. In an embodiment, the lock value structure 120 may store a system change number that is associated with a unit of work of the associated transaction branch of the distributed transaction.

The process flows here have been described as performed by the cluster 106. It should be noted that this is for illustrative purposes only. For purposes of the present invention, other entities, which may include but are not limited to the resource manager 110, may also be used to implement the process flows. Furthermore, the resource manager 110 may or may not be resident in the cluster 106 in differing embodiments, so long as the resource manager 110 can perform the process flows as described herein. Thus, other variations as to who perform the process flows are within the scope of the present invention.

For the purpose of illustration, in some embodiments, the distributed transaction has been described as comprising one or more transaction branches. In some other embodiments of the present invention, however, the distributed transaction is defined as comprising two or more transaction branches. In those other embodiments, the global state of the distributed transaction comprises two or more statuses for the two or more transaction branches. Similar steps to those illustrated in FIGS. 2 and 3 and their accompanying texts may be used in those other embodiments where the distributed transaction comprises at least two transaction branches.

For the purpose of illustration, only two nodes have been shown in the cluster. However, this invention is not limited to only two nodes. In some embodiments, more or less nodes may be in the cluster. Furthermore, nodes may be dynamically added or removed from the cluster. Thus, these and other variations, in various embodiments, of the node configuration of the cluster are within the scope of the present invention.

### Hardware Overview

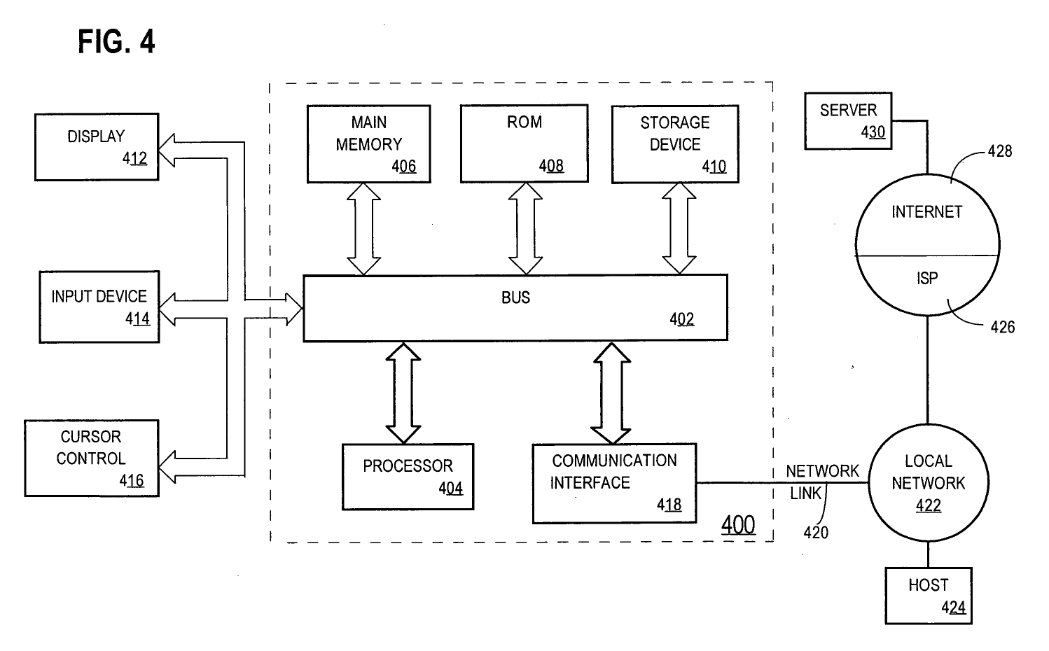

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to an embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infrared data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method, comprising:
a computer system, comprising two or more server instances, executing one or more transaction branches of a distributed transaction that is managed by a transaction manager executing on a node different from said two or more server instances; and
storing, within said computer system, information in association with said distributed transaction that indicates a status of said distributed transaction.

2. The method as recited in claim 1, wherein said information in association with said distributed transaction is stored in association with a global lock.

3. The method as recited in claim 1, wherein said status of said distributed transaction comprises one or more statuses, each being associated with one of said one or more transaction branches.

4. The method as recited in claim 1, further comprising using said information in association with said distributed transaction to detect an attempt to create a transaction branch that is duplicative to an existing transaction branch in the distributed transaction.

5. The method as recited in claim 1, further comprising associating a global transaction identifier with said distributed transaction and using said information in association with said distributed transaction to detect an attempt to create another distributed transaction associated with said global transaction identifier.

6. The method as recited in claim 2, wherein said information in association with said distributed transaction is stored in one or more lock value structures in association with said global lock.

7. The method as recited in claim 6, wherein at least one of said one or more lock value structures is associated with a unit of work performed by a server process.

8. The method as recited in claim 7, wherein said unit of work comprises preparing for committing said distributed transaction.

9. The method as recited in claim 6, wherein said information in association with said distributed transaction is stored in a variable-sized data structure that comprises said one or more lock value structures in association with said global lock.

10. The method as recited in claim 1, wherein said information comprises a branch status for one of the transaction branches, wherein said branch status comprises an indication of a success or a failure relating to performing a two-phase transaction commitment for the one of the transaction branches.

11. The method as recited in claim 6, wherein one of said one or more lock value structures comprises an address of undo records and a system change number that is associated with a unit of work of the associated transaction branch of said distributed transaction.

12. The method as recited in claim 1, wherein said two or more server instances form a server cluster for a single database source.

13. The method as recited in claim 1, further comprising:
receiving a request to prepare for committing a transaction branch;
determining said status of said distributed transaction using said information in association with said distributed transaction, wherein said status of said distributed transaction comprises one or more statuses for one or more transaction branches that includes said transaction branch; and
managing preparation for committing said transaction branch based on said status of said distributed transaction.

14. A computer-readable medium carrying one or more sequences of instructions which, when executed by one or more processors, causes the one or more processors to perform the method recited in claim 1.

15. A computer-readable medium carrying one or more sequences of instructions which, when executed by one or more processors, causes the one or more processors to perform the method recited in claim 2.

16. A computer-readable medium carrying one or more sequences of instructions which, when executed by one or more processors, causes the one or more processors to perform the method recited in claim 3.

17. A computer-readable medium carrying one or more sequences of instructions which, when executed by one or more processors, causes the one or more processors to perform the method recited in claim 4.

18. A computer-readable medium carrying one or more sequences of instructions which, when executed by one or more processors, causes the one or more processors to perform the method recited in claim 5.

19. A computer-readable medium carrying one or more sequences of instructions which, when executed by one or more processors, causes the one or more processors to perform the method recited in claim 6.

20. A computer-readable medium carrying one or more sequences of instructions which, when executed by one or more processors, causes the one or more processors to perform the method recited in claim 7.

21. A computer-readable medium carrying one or more sequences of instructions which, when executed by one or more processors, causes the one or more processors to perform the method recited in claim 8.

22. A computer-readable medium carrying one or more sequences of instructions which, when executed by one or more processors, causes the one or more processors to perform the method recited in claim 9.

23. A computer-readable medium carrying one or more sequences of instructions which, when executed by one or more processors, causes the one or more processors to perform the method recited in claim 10.

24. A computer-readable medium carrying one or more sequences of instructions which, when executed by one or more processors, causes the one or more processors to perform the method recited in claim 11.

25. A computer-readable medium carrying one or more sequences of instructions which, when executed by one or more processors, causes the one or more processors to perform the method recited in claim 12.

26. A computer-readable medium carrying one or more sequences of instructions which, when executed by one or more processors, causes the one or more processors to perform the method recited in claim 13.
